(19) United States
(12) Patent Application Publication
(10) Pub. No.: US 2005/0246301 A1
(43) Pub. Date: Nov. 3, 2005

(54) System and Method to distribute reasoning and pattern matching in forward and backward chaining rule engines

(75) Inventors: Peter Lin, Worcester, MA (US); Said Tabet, Natick, MA (US)

Correspondence Address: PETER LIN, 88 BJORKLUND AVE, WORCESTER, MA, 01605-1071, US

(73) Assignees: Peter Lin, Worcester, MA (US); Said Tabet, Natick, MA (US)

(21) Appl. No.: 10/708,696

(22) Filed: Mar. 18, 2004

(51) Int. Cl. G06N 5/02

(52) U.S. Cl. 706/47

(57) ABSTRACT

Distributed pattern matching defines extensions and improvements to the RETE algorithm and to the forward chaining method of inference in rule systems. The same approach is envisaged for a goal-driven, backward chaining inference method where data is used to satisfy new goals in an interactive session between different engines, different systems, or between a system and a user interface. Utilizing techniques from Remote Procedure Calling (RPC), distributed processing, parallel processing and grid computing, the invention defines a novel algorithm to implement a system capable of distributed pattern matching. Reasoning over large data sets exceeding millions of rows in a reactive mode with a single engine is difficult due to hardware limitations. Using a cluster of inexpensive systems, reasoning over large datasets is more efficient and provides better scalability and response time. Distributed pattern matching is a significant innovation and enables rule engines to reason over large sets of data. Current rule engines scale vertically by upgrading the hardware. Distributed pattern matching has no preference towards vertical or horizontal scaling. There are classes of problems that require a rule engine to reason over the entire database. This type of problem is difficult to solve with collaborative reasoning, where multiple symmetric systems are used to process discrete blocks of data. Distributed pattern matching overcomes the limitations of collaborative reasoning and helps solve a new class of problems. This innovation will also facilitate system integration, lower costs of maintenance in large organizations, and improve the performance and quality of applications in many areas, including: electronic procurement, e-government, real-time data management systems, insurance systems, enterprise resource management, and personalization, to just cite a few applications.

### BACKGROUND OF INVENTION

Rules engine technology is the product of research in Artificial Intelligence and intelligent systems. Throughout the 1970's, 80's and 90's, researchers have solved some complex computing challenges. One of the most efficient and well tested algorithms is RETE. It was originally described by Charles Forgy.

REFERENCE: 1. Rete: A Fast Algorithm for the Many Pattern/ Many Object Pattern Match Problem* by Charles L. Forgy Department of Computer Science. Carnegie-Mellon University.

### DETAILED DESCRIPTION

Distributed reasoning, unlike collaborative agents provides methods by which multiple rule engines reason over large datasets in real-time. Whereas collaborative agents use agents to reason over discrete problems, it cannot reason over large sets of data. Furthermore, collaborative agents” techniques require the engine to load all necessary data within the same engine. For small datasets, these techniques prove to be powerful, but they do not scale for large datasets.

A forward chaining rule engine utilizing RETE algorithm, can reason over large datasets when nodes are distributed to other systems. This allows the system to match on a specific instance of a class (also called business object) without requiring the object instance reside in the same working memory and be locally available. It is important to note the engine will reason over shared data resident in other engines using data steams. This reduces the memory requirements and improves efficiency. It also enables the engines to share all or part of their reasoning network and distribute the process. Distributing nodes of a set of rules across multiple systems allows each engine to perform pattern matching on a single object instance and route the results to the originating system. Unlike load balancing techniques, a true distributed reasoning system does not require all systems of a cluster to deploy identical sets of rules, which creates redundant rules within the environment and increases maintenance costs. In a distributed reasoning/distributed pattern matching system, each system deploys a different set of rules (also called module or rule set), based on its own needs and configuration requirements. At runtime, the rule engines monitor resource utilization and distribute nodes dynamically and on demand.

Prior techniques relied on load balancing techniques to prioritize and categorize atomic processes. This approach requires every system to have all required data locally, leading to multiple data caches. In a production environment with large datasets, each system cannot load all required data and data synchronization becomes a potential problem.

1. A rule engine which implements the RETE algorithm with novel extension, which support distributed pattern matching.

2. A system according to claim 1 converts an object structure into un-ordered facts within the engine.

3. A system according to claim 1 implements the notion of working memory as described in reference article 1.

4. Input nodes as defined in reference article 1 are extended with the capability to route objects to a remote rule engine or use it locally.

5. Join nodes as defined in reference article 1 are extended with the capability to route matched patterns locally or remotely

6. Terminal nodes as defined in reference article 1 are extended with the capability to route matched patterns locally or remotely

7. A template according to claim 2 uses a linear sequence of nodes representing the pattern to match for an object.

8. A system according to claim 1 implements an abstraction layer for retrieving remote facts.

9. A system according to claim 1 uses a call back mechanism between the working memory and the input objects and the object instance uses the call back mechanism to notify the engine when data changes.

10. A system according to claim 1 requires object instantiations to implement a base interface for the call back mechanism.

11. A system according to claim 1 monitors the resource usage.

12. A system according to claim 1 uses rules to manage the distribution of nodes to remote systems.

13. A system according to claim 1 distributes pattern matching by serializing the nodes to a remote system.

14. A system according to claim 1 distributes the input, join, terminal and intra-element nodes to a remote system.

15. Distributed nodes according to claim 14 maintains a list of remote systems which depend on the results of pattern matching.

16. A system according to claim 1 will serialize the values of an object to a remote system if the corresponding pattern matches against a remote object pattern.

17. A system according to claim 1 may serialize the object and its values to a remote system if the object contains procedural logic and functional attachments including remote service method calls.

18. A system according to claim 1 may serialize the values of an object to a remote system and the receiving system may create a new instance of the object for pattern matching.

19. Objects according to claims 16 to 18 are considered temporal by the rule engine if the object's original instance and nodes reside on a remote system.

20. A system according to claim 1 defines three types of input channels: standard input, data distribution and node distribution.

21. A system according to claim 1 defines a set of APIs to handle incoming events and requests for pattern matching.

22. Input according to claim 21 is defined as standard input channel.

23. A system according to claim 1 defines a data distribution channel for sending and receiving remote data between rule engines.

24. A system according to claim 1 defines a pattern distribution channel for distributing RETE nodes.

25. A system according to claim 1 considers an object as temporal if it was sent through the data distribution channels.

26. Temporal objects according to claim 19 and 25 are used by the engine to perform pattern matching and these objects are discarded immediately after the pattern matching process is complete.

27. A system according to claim 1 will route the results of claim 26 back to the originating system using the data distribution channel.

28. A system according to claim 1 will update the index of the join and terminal nodes as a result of pattern matching according to claim 26.

29. A system according to claim 1 processes the RHS of the rule if the original event/request began locally.

30. A system according to claim 1 uses messaging system to route new event/request to a cluster of rule engines.

31. A messaging system according to claim 30 filters new messages and routes them to the correct engine.

32. A system according to claim 1 uses messaging system to route the final result to the recipient.

33. A system according to claim 1 contains a component responsible for communicating with the messaging system.

34. A messaging component according to claim 33 is responsible for processing inbound events and generating new messages for outbound publication.

35. A system according to claim 1 prefers to process new events asynchronously using the messaging system.

36. Distributed nodes according to claim 14 contain information about the originating engine, a timestamp of when the nodes were distributed and a priority attribute.

37. The priority attribute according to claim 36 may be used by the engine to remove the nodes, if all local object instances have been removed from the working memory.

38. Distributed nodes according to claim 14 will not be removed from the local pattern matching network, if data for those patterns is still being used, either in active rules about to fire or in remote procedural attachment calls.

39. A system according to claim 1 may forward node distribution messages, if the system does not have sufficient resources.

40. A forward message according to claim 19 must retain the location of the originating engine and add the current engine's unique runtime name to a list of recipients.

41. A system according to claim 1 will notify the producer of the node distribution message of success or failure.

42. Distributed nodes according to claim 14 may be distributed at deployment time.

43. A system according to claim 1 will set an attribute of the input node to indicate that the pattern has been distributed.

44. An input node according to claim 43 will maintain a list of the remote systems and the total number of data objects routed remotely.

45. A system according to claim 1 may not attempt to distribute nodes that were distributed by another rule engine. Instead, it should notify the originating engine it cannot receive additional data until resources are available.

46. A system according to claim 1 may randomly select a remote engine to route data to, if the pattern is distributed to more than 1 engine.
